(19) United States
(12) Patent Application Publication
(10) Pub. No.: US 2017/0163089 A1
(43) Pub. Date: Jun. 8, 2017

(54) Control of Multiple Battery Groups

(71) Applicant: East Penn Manufacturing Co., Lyon Station, PA (US)

(72) Inventors: Clemens Van Zeyl, Sydney (AU); Brian McKeon, Sydney (AU)

(73) Assignee: East Penn Manufacturing Co., Lyon Station, PA (US)

(21) Appl. No.: 15/439,509

(22) Filed: Feb. 22, 2017

Related U.S. Application Data
(63) Continuation of application No. PCT/US15/46317, filed on Aug. 21, 2015.

(30) Foreign Application Priority Data
Aug. 22, 2014 (AU) 2014903323

(51) Int. Cl. H02J 9/06; H01M 10/42; H02J 7/00; H02M 3/04; H02M 7/04; H02M 7/44

(52) U.S. Cl. CPC H02J 9/062; H02M 7/04; H02M 7/44; H02J 7/0068; H02J 7/007; H02M 3/04; H01M 10/425; H01M 2220/10

(57) ABSTRACT

A power conversion and control system includes a power battery group and an energy battery group. The energy battery group is connected to a DC converter, the DC converter output being connected to a bus, and the power battery group is connected directly to the bus, so that operatively the voltage of the bus is variable.

The bus may be connected to an inverter for output to a load, via a transformer. A difference in response time is provided between the inverter and the DC converter.

The bus may be connected to the grid via a grid rectifier, and to the load via a load inverter.

In an alternative, a power conversion and control system, includes a battery group, connected to the input of a load inverter, and to the input of a grid rectifier, wherein the system is adapted to provide frequency regulation power to the grid, to supply load power to a load via the load rectifier, and to provide charging power to maintain the state of charge of the battery, wherein signals indicative of the load power, frequency regulation power and charging power are summed by an adder in order to provide a control signal for the grid rectifier.

### CROSS-REFERENCE TO RELATED APPLICATIONS

This application is a continuation of PCT International Application No. PCT/US15/46317 filed Aug. 21, 2015, which claims priority under 35 U.S.C. §119 to Australian Patent No. 2014903323 filed Aug. 22, 2014.

### FIELD OF THE INVENTION

The present invention relates to the control of battery groups within an energy storage system.

### BACKGROUND

Battery energy storage (BES) systems allow for the storage and discharge of electrical energy within installations of many kinds. These may include systems which store energy from power sources, such as wind or solar systems, back-up power supplies such as uninterruptible power supplies (UPS), to assist in power regulation, or for other purposes.

In some applications, BES systems may have multiple purposes, or operational modes that require independent control of different battery groups. There are two common means of independently controlling battery groups. The first case uses an AC/DC inverter (inverter) for each battery group. The second case uses a DC/DC converter (DC converter) per group.

The first case is illustrated in prior art FIG. 1. Battery groups 10, 11 each have an associated inverter 12, 13. As is typical, inverters 12, 13 share a common transformer 20. The transformer is connected to the grid 30.

The second case is illustrated in prior art FIG. 2. Battery groups 10, 11 are each connected to an associated DC converter 14, 15. DC converters 14, 15 output to a common bus 18, at a fixed voltage, and then power is converted to AC via a common inverter 16 and transformer 21.

In both configurations the power flow from each battery group may be completely different. In FIG. 1, the different power flows are summed electro-magnetically in transformer 20. In FIG. 2, the power flows are summed on the common DC bus.

There are advantages and disadvantages of each configuration. In the case shown in FIG. 1, there is a single level of power conversion performed by inverters 12, 13, and therefore in principle this configuration has a higher efficiency than the case of FIG. 2. The arrangement of FIG. 2 has two levels of power conversion, in DC converters 14, 15 and in common inverter 16.

In FIG. 2, common inverter 16 can be sized for the sum of the power flows. For example, if each DC converter is defined as 1 per unit (“pu”) power, then the Inverter could be rated at less than 2 pu power in a scenario where the full power of both battery groups is never used simultaneously. This is in contrast to FIG. 1, where each inverter has to be rated 1 pu (in total 2 pu power).

For many applications it is desirable to install a battery group designed to manage relatively high variability with high cycling, which requires a minimal amount of energy storage (such as frequency regulation or solar photovoltaic smoothing), which we will refer to as a power battery group, and another battery group designed for delivery of energy, which requires a relatively large amount of energy storage (such as demand management, energy shifting, and backup power including uninterruptible power), which we will refer to as the energy battery group.

It is an object of the present invention to provide an effective method, apparatus and system for an arrangement including both a power battery group and an energy battery group.

### SUMMARY

In a first broad form, the present invention provides an arrangement in which the energy battery group is connected to a bus via a DC converter, and the power battery group is directly connected to the bus, the bus outputting to a common inverter.

According to one aspect, the present invention provides a power conversion and control system, including a power battery group and an energy battery group, the energy battery group being connected to a DC converter, the DC converter output being connected to a bus, and the power battery group is connected directly to the bus, so that operatively the voltage of the bus is variable.

In some implementations, the bus is connected to an inverter for output to a load, preferably via a transformer. Preferably, a difference in response time is provided between the inverter and the DC converter

In other implementations, the bus is connected to the grid via a grid rectifier, and to the load via a load inverter.

According to another aspect, the present invention provides A power conversion and control system, including a battery group, connected to the input of a load inverter, and to the input of a grid rectifier, wherein the system is adapted to provide frequency regulation power to the grid, to supply load power to a load via the load rectifier, and to provide charging power to maintain the state of charge of the battery, wherein signals indicative of the load power, frequency regulation power and charging power are summed by an adder in order to provide a control signal for the grid rectifier.

### BRIEF DESCRIPTION OF THE DRAWINGS

Implementations of the present invention will now be described with reference to the accompanying figures, in which:

FIG. 1 is a schematic circuit diagram of a first prior art system;

FIG. 2 is a schematic circuit diagram of a second prior art system;

FIG. 3 is a schematic diagram of a first implementation of the present invention;

FIG. 4 is a schematic diagram of a first application of the first implementation;

FIG. 5 is a schematic diagram of a second application of the first implementation

FIG. 6 is a schematic diagram of an implementation for a UPS system with one battery group;

FIG. 7 is a schematic diagram of an implementation for a UPS system with two battery groups;

FIG. 8 is a schematic diagram illustrating a control system for a system according to FIG. 5;

FIG. 9 is a schematic diagram of an alternative control system for a system according to FIG. 5;

FIG. 10 is a schematic diagram of a control system for a system according to FIG. 6; and

FIG. 11 is a schematic diagram of a control system for a system according to FIG. 7.

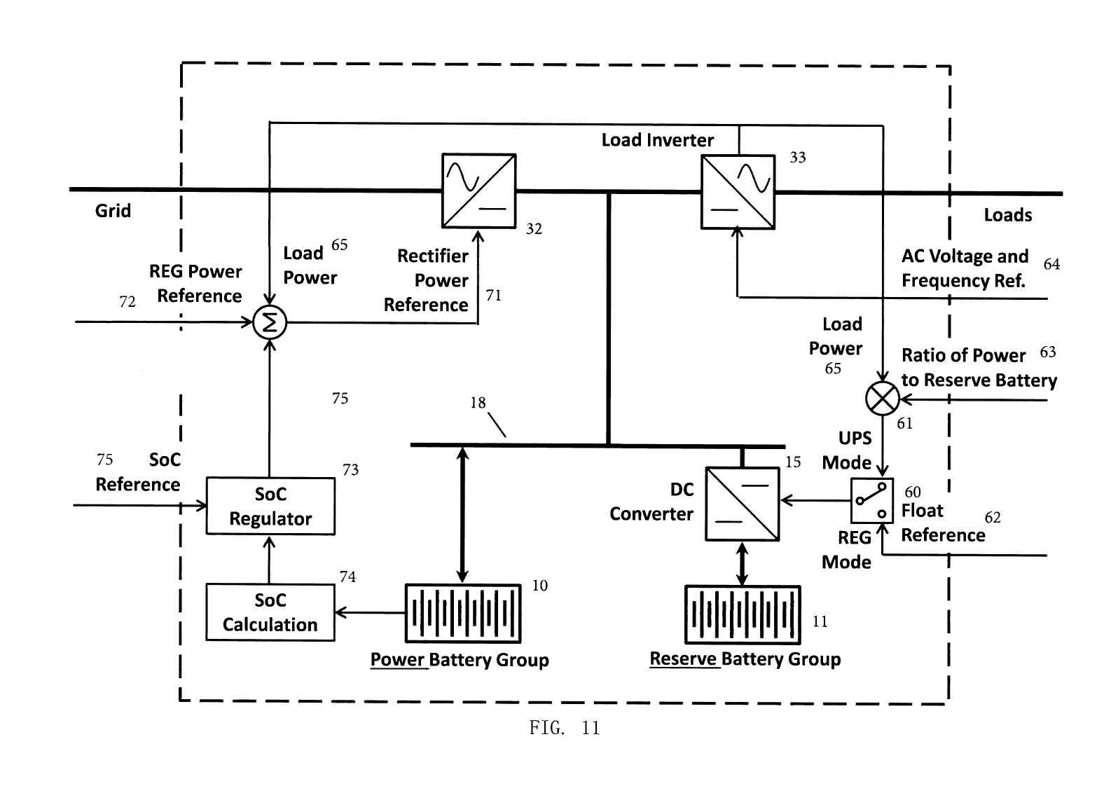

### DETAILED DESCRIPTION OF THE EMBODIMENT(S)

The present invention will be described with reference to various examples, which will be discussed below. It will be understood that these are illustrative of the present invention, and not limitative of the scope thereof. In particular, many alternative conventional components can be used to implement the invention. Whilst lead acid batteries are the primary battery discussed, any other suitable battery, for example lithium ion, lithium polymer, nickel cadmium, redox or other flow batteries, or any other such device may be used. The present invention is also applicable to other means for storing electrical energy, for either or both battery groups, for example capacitors, super capacitors, or other mechanical, chemical or electrical storage devices, and all such devices (or combinations thereof) are to be understood as falling within the scope of the term battery.

Similarly, whilst particular devices are discussed in the context of inverters, converters, rectifiers, switches and transformers, it will be understood that these may be conventional, off the shelf devices, with ratings and applications consistent with the particular implementation required. While the discussion will be in the context of one energy battery group and one power battery group, it will be understood that the principles of the present invention can be applied to more complex systems.

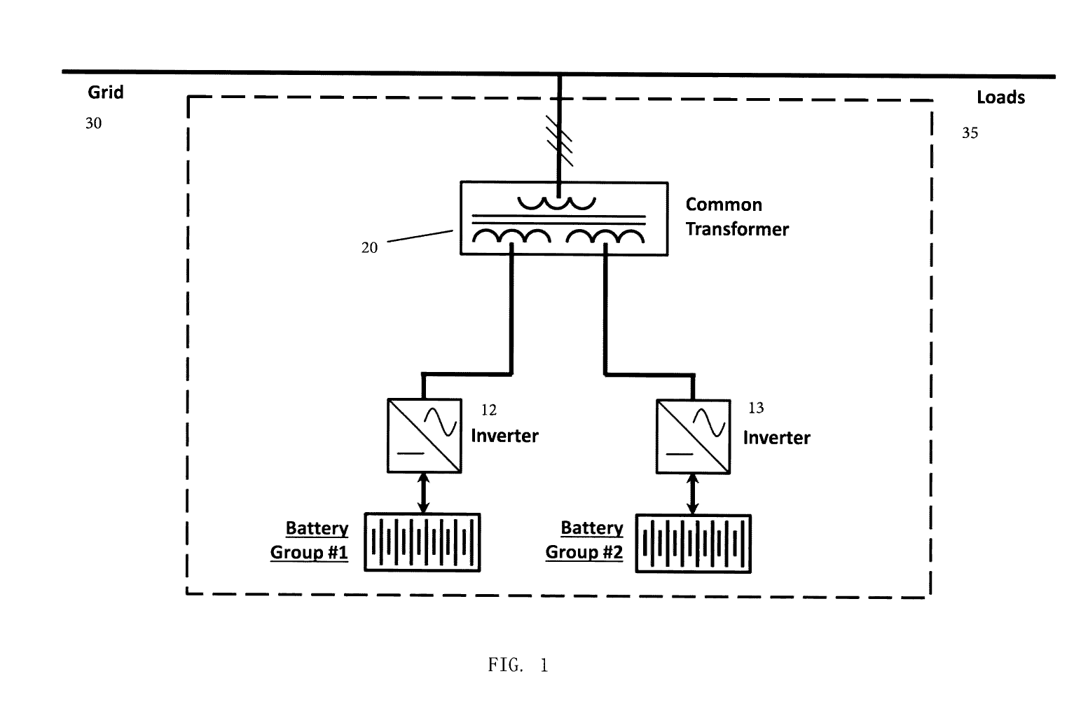

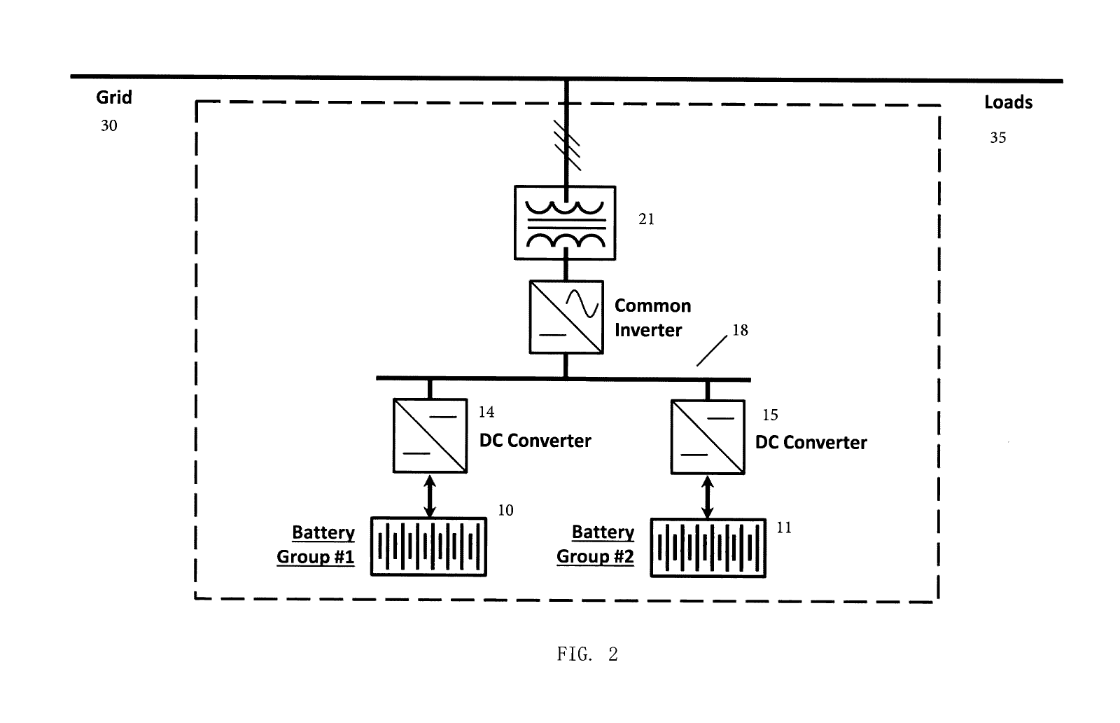

The prior art systems discussed in relation to FIGS. 1 and 2 may both be considered as shunt BES systems, because they are connected in parallel to the grid and the load. The implementations of the present invention to be discussed may be regarded as series or in line systems, because they are connected in series with the grid and load.

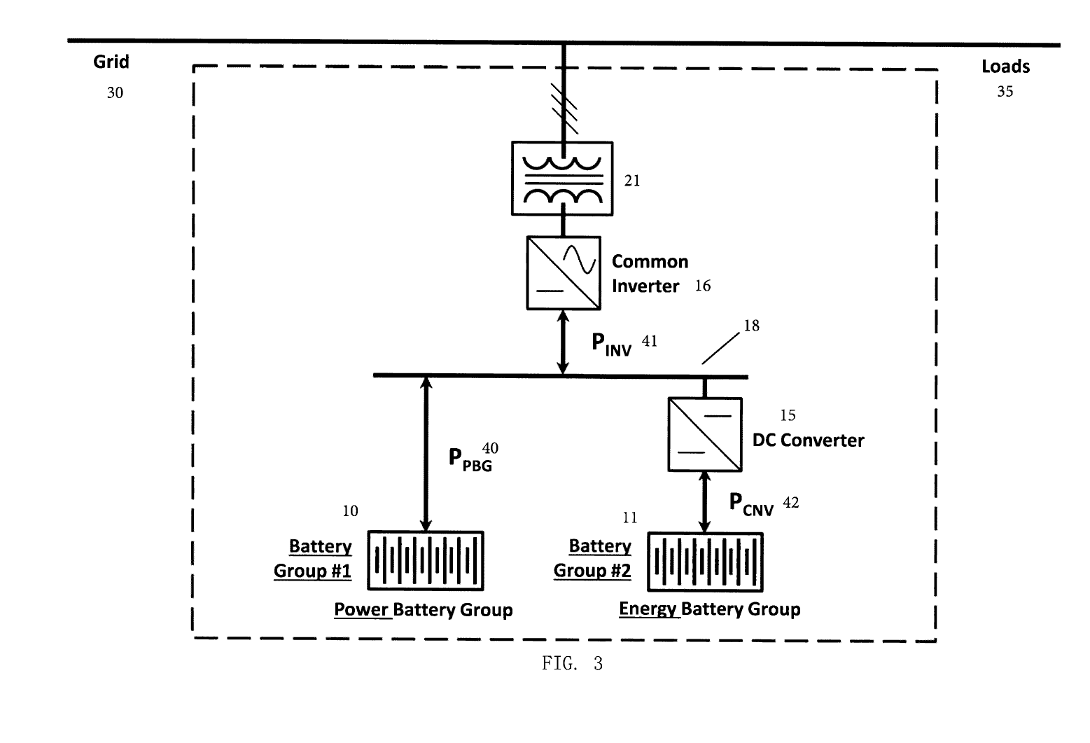

FIG. 3 illustrates one implementation of the present invention. The power battery group 10 is connected to bus 18 directly. The energy battery group 11 is connected to DC converter 15, which is then connected to the bus 18. Output from the bus 18 is through common inverter 16 and transformer 21.

Common inverter 16 controls overall power flow from both power battery group 10 and energy battery group 11, whereas DC converter 15 solely controls power flow from the energy battery group 11. Therefore the power flow in the power battery group (P_{PBG}) is the difference between the overall power flow controlled by the common inverter (P_{INV}) and the power flow from the energy battery group controlled by DC converter (P_{CNV}), as shown in Equation A:

P_{PBG}=P_{INV}−P_{CNV}

It is noted that in the system of FIG. 2, the DC voltage at the terminals of the common inverter 16 is constant, which by definition means the inverter side of each DC converter is also constant. This is a common assumption within the industry. However, for the system shown in FIG. 3, having a common inverter and DC converter (the hybrid system), the DC voltage input to the inverter varies within the required range of the power battery group 10, and therefore the inverter side of the DC converter is also variable. This is a distinct difference between the hybrid solution of the present implementation, and the prior art systems.

In respect to control of power flow, both the common inverter and DC converter have power regulators to control power flow, but the response time between the regulators must have an adequate separation, for example approximately 10 decibels, to prevent instability. As the purpose of energy battery group 11 is to deliver power over a long duration, whereas the purpose of power battery group 10 is to delivery fast response power over a relatively short duration, having the required approximately 10 decibels of separation is compatible with the two different battery groups. It will be appreciated that the exact value is a matter of design choice in a particular implementation, as would be understood by those skilled in the art. To put it another way, the DC converter is always mated with the energy battery group and has a slow response power regulator.

There are several applications of the hybrid shunt system shown in FIG. 3, including, but not limited to, the following combinations:

| Application | power battery group | energy battery group |
|---|---|---|
| #1 | frequency regulation | Demand Management or energy |
| | | Shifting or both |
| #2 | Renewable energy | energy Shifting |
| | smoothing | |
| #3 | frequency regulation | backup power including |
| | | Uninterruptible power |
| #4 | Renewable energy | backup power including |
| | smoothing | Uninterruptible power |

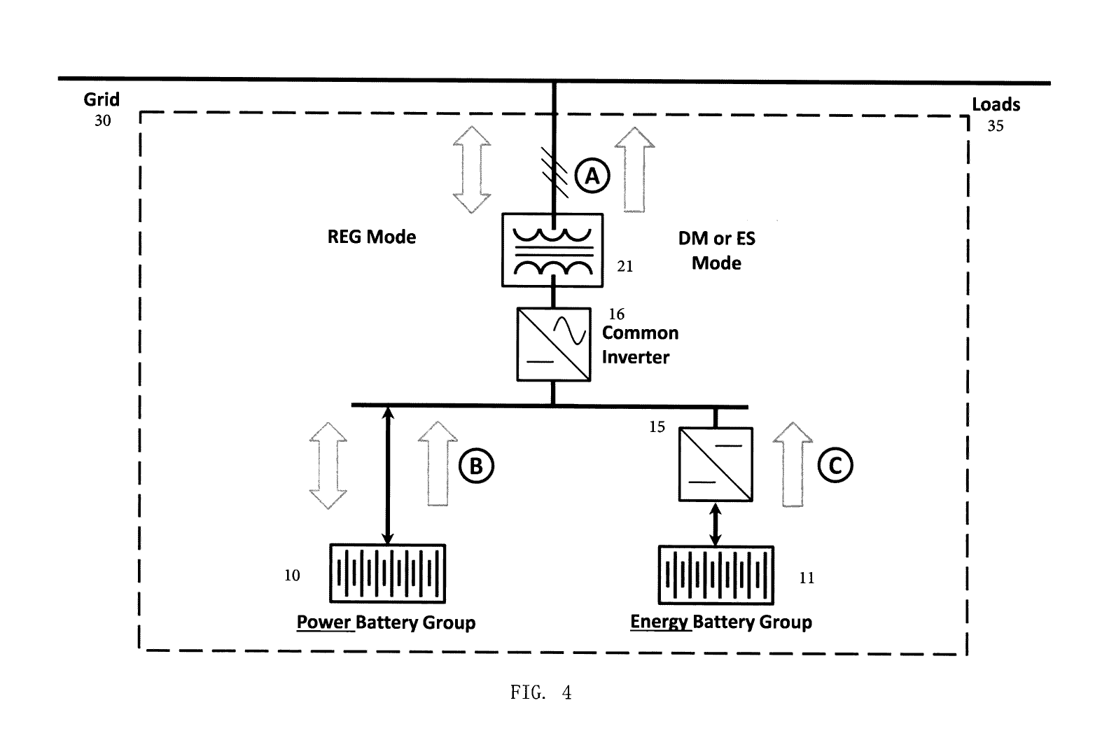

An example of Application #1 is shown in FIG. 4. In this example the shunt hybrid system is either operated in a frequency regulation mode (“REG Mode”) or a demand management mode (‘DM Mode”) or energy shifting mode (“ES Mode”). In the REG Mode the shunt hybrid system delivers power exclusively to the grid from the power battery group on command of a ‘frequency regulation reference’ supplied by a remote control system, typically the electrical system operator. In the DM Mode or ES Mode, power/energy may be delivered by both the power battery group and energy battery group simultaneously, with the power battery group typically delivering less power than the energy battery group as can be seen illustrated by the graphs in FIG. 4.

The ratio of power/energy delivered between the battery groups is determined by the power reference for the DC converter as determined by Equation A. This is demonstrated in FIG. 4 by power flow “A” equalling “B” plus “C”.

Another operation mode is delivery of power serially (in sequence) such the power battery group is only used once the energy battery group is nearly spent.

Application #2 is almost identical to Application #1, other than the REG Mode is replaced by a renewable smoothing mode (“SM Mode”), and the SM Mode can occur simultaneously with the DM or ES Mode. In other words, power battery group and energy battery group can operate together to manage power variability and time of energy delivery.

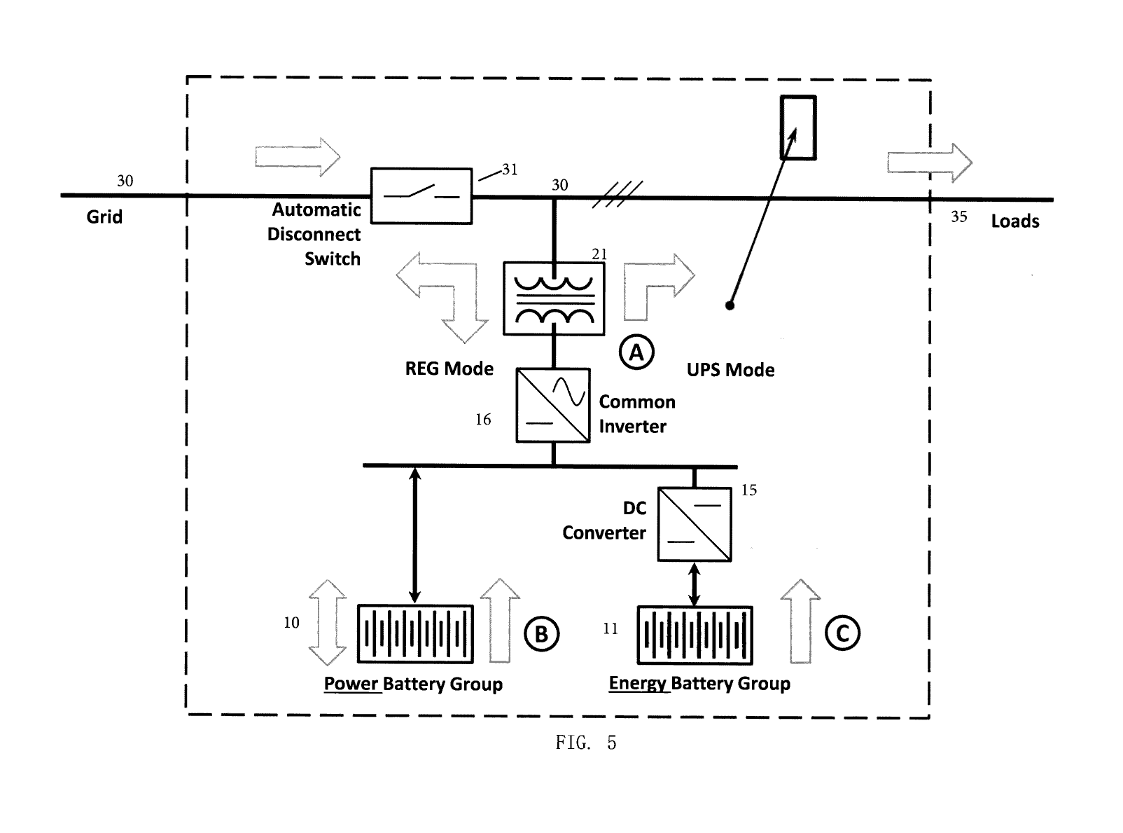

An example of Application #3 is shown in FIG. 5. Like Application #1, the power battery group 10 delivers frequency regulation power to the grid during REG Mode. However, in this application the energy power group 11 is designed to deliver energy to the load, as shown by the arrow in the diagram, when the automatic disconnect switch 31 is opened with a power disturbance (power quality event) on the grid.

Again, similar to Application #1, in addition to the energy power group 11, power/energy can also delivered by the power battery group in a ratio determined by the DC converter power reference (i.e. B=A−C, where C is set by the DC converter power reference, and A is set by the power reference for the BES System). Alternatively the power can be delivered sequentially from each battery group.

Application #4 is almost identical to Application #3, other than the REG Mode is replaced by a renewable smoothing mode (“SM Mode”).

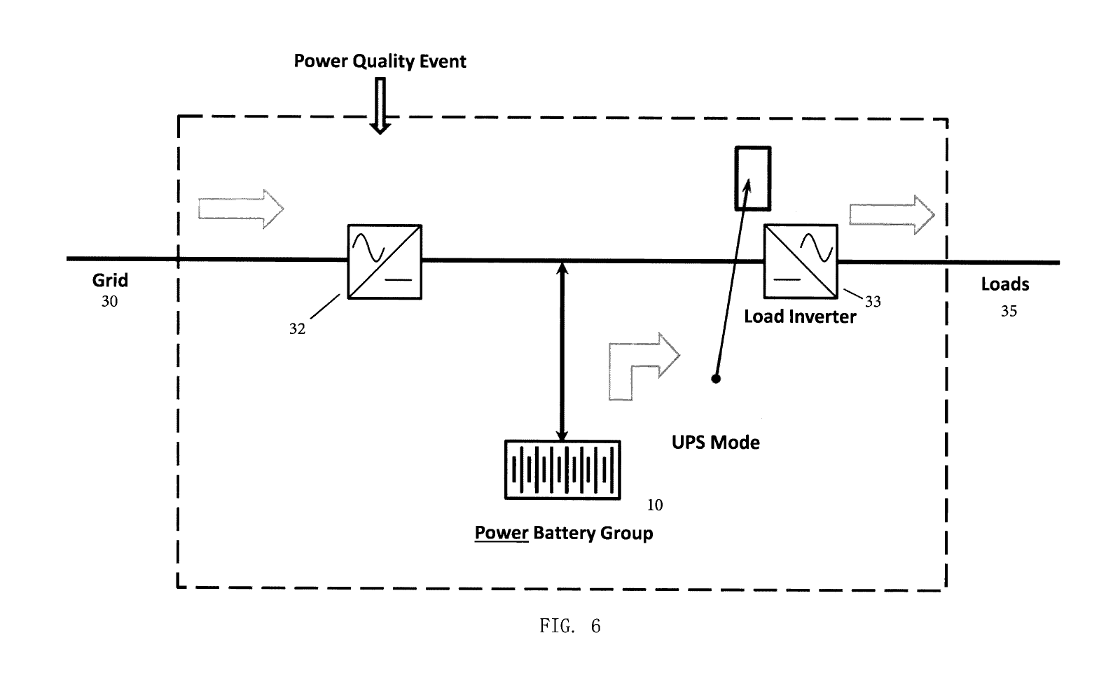

Mixing of two different groups of battery according to the present invention can also be applied to an inline uninterruptible power supply (referred to in the industry as an “Inline UPS” or “Online UPS”, and herein as an “Inline BES System”) where the power converters, a rectifier and an inverter, are in series with the grid (connected between the grid and the load). A UPS system is illustrated in FIG. 6.

Connected between the grid rectifier 32, on the grid side, and the load inverter 33, on the load side”), is a power battery group 10 designed to discharge energy when the grid rectifier can no longer do so because of a power quality event.

Inline BES Systems have traditionally been used only in UPS applications where the batteries are rarely worked. This presents an opportunity to utilize the batteries for a second purpose, and considering that UPS applications are standalone, a desirable second application is frequency regulation where the only requirement is a grid connection, which is Application #3 describe above. The general application of a battery system to these shared uses is described in the applicant's co-pending PCT application PCT/AU2013/000375, the disclosure of which is hereby incorporated by reference.

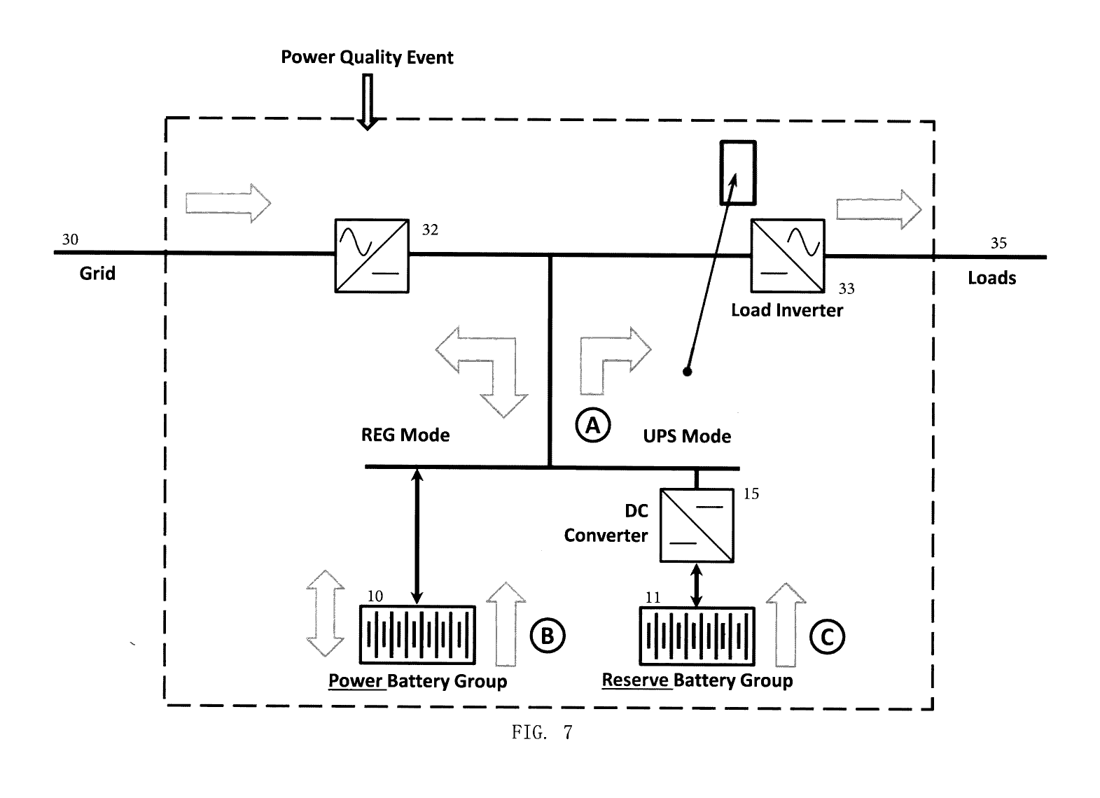

Furthermore, UPS applications require a very high-degree of reliability, so it is desirable to have a set of reserve batteries to ensure the UPS function is always available. One implementation of such a system is shown in FIG. 7.

The operation of the power battery group and the Reserve Battery Group is very similar to that of the shunt hybrid BES System shown in FIG. 5, but frequency regulation is now controlled by the grid rectifier 32, and the UPS power is controlled by the load inverter 33. Furthermore, like the shunt hybrid BES System of FIG. 5, the power delivered by the power battery group is a function of the power demanded by the Load Inverter less the power commanded by the DC converter (i.e. B=A−C, where C is set by the DC converter power reference, and A is power delivered by the Load Inverter).

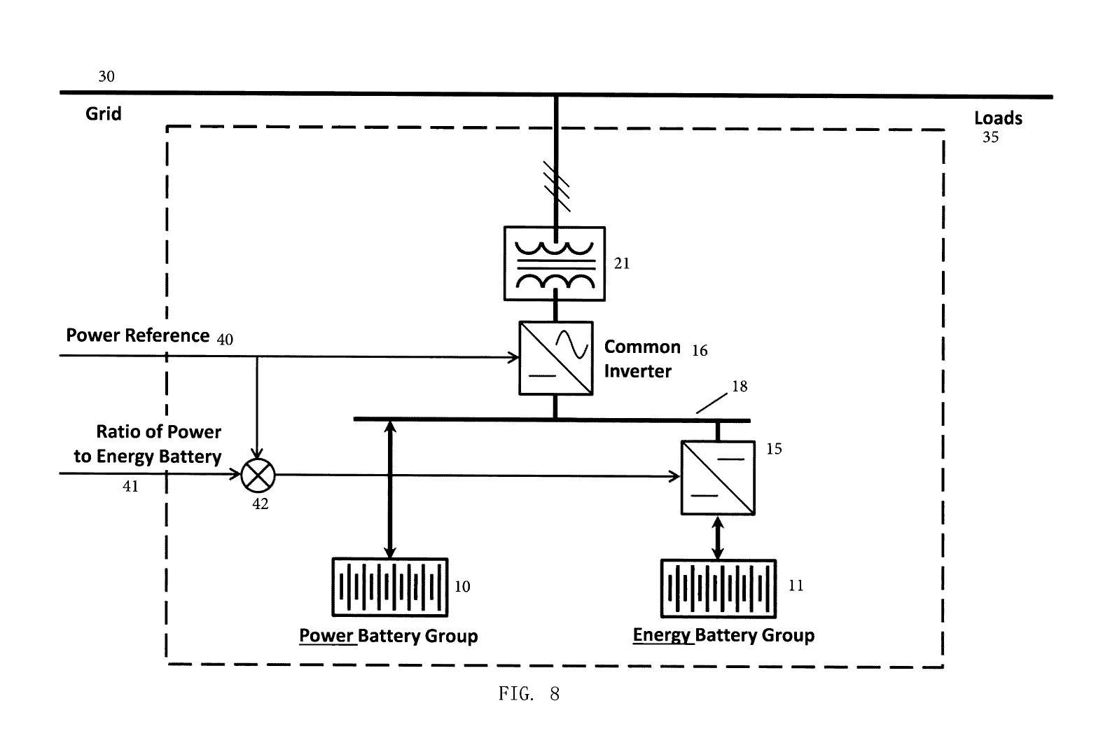

The control architecture for a shunt hybrid BES System is simple, however novel. The basic control architecture utilizes a multiplier 42 to ratio 41 a portion of the BES System power reference 40 as the reference for the DC converter 15, as shown in FIG. 8. For example, in Application #1, FIG. 4, a suitable ratio would be 1.0:0.0 in the frequency regulation mode such that the power battery group is doing all the work. In the demand management mode the ratio typically would be 1.0:0.7 such that 30% of the work would be performed by the power battery group and 70% by the energy battery group. Also, this ratio can vary over time. For example, in demand management mode initially the energy battery group could do all the work (a ratio of 1.0:1.0) and as its state of charge reaches its bottom limit, the ratio could be decreased to transfer most of the work to the power battery group. In this manner longevity of power battery group could be increased (i.e. its energy throughput minimized). In some implementations, there may be advantages in allowing the power battery group to take the role of the energy battery for some periods of time, or for both battery groups to respond with a common or similar power response.

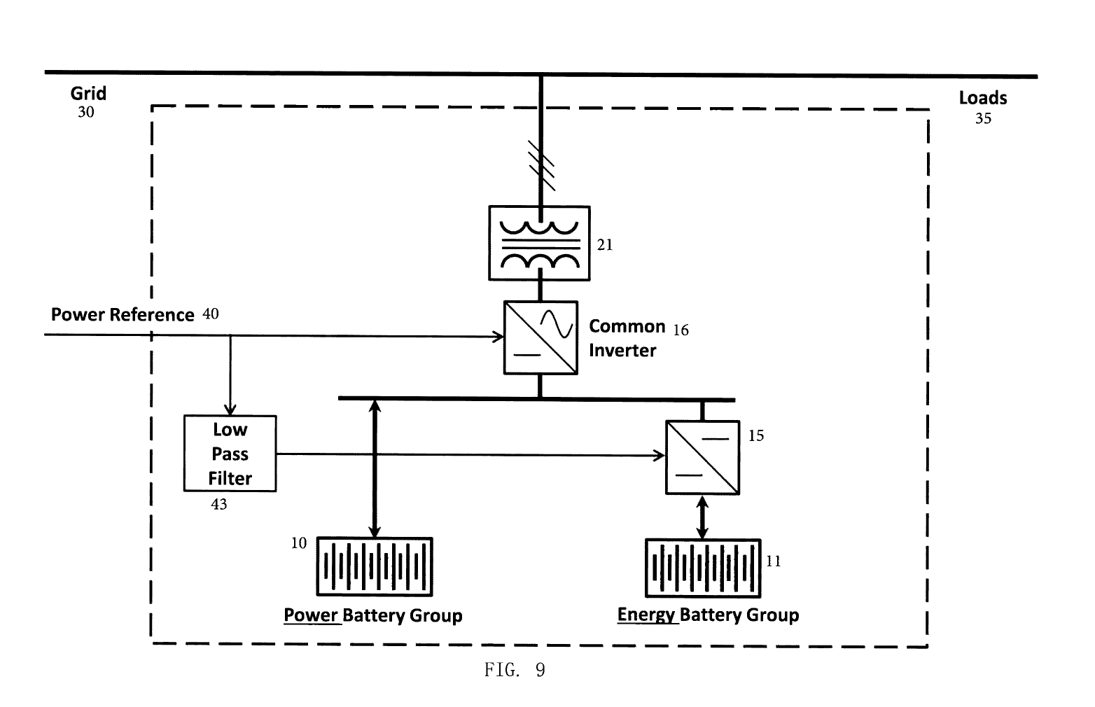

In certain applications it may be desirable to simply have the energy battery group 11 follow the power reference 40 in a delayed fashion at a low rate of change, or to act as a source of energy to help maintain the state of charge of the power battery in a target range of charge by acting as a charging source. This can be accomplished by replacing the multiplier with a low-pass filter 43, shown in FIG. 9. The low-pass filter could be as simple as calculating a rolling average of the past power reference for the BES System. Alternatively, another appropriate algorithm which shares the power demand appropriately between the power battery group 10 and the energy battery group 11 may be used. An example of this is a micro-grid application where the BES System is used to balance generation with demand. Any fast response requirements would be performed by the power battery group, but bulk energy requirements would be performed by the energy battery group.

It will be understood that the discussion above is approbation for the application discussed, the architecture possible for implementations of the present invention provides the flexibility to divide the provision of power between the two battery groups in a flexible manner, consistent with and responsive to the specific requirements.

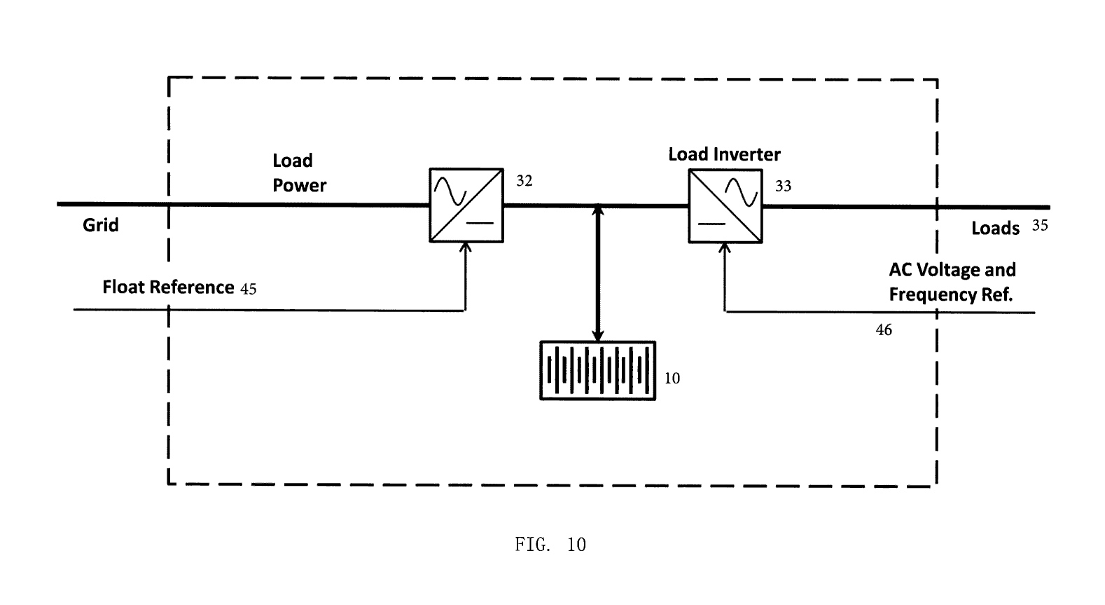

The controls for an inline BES System are relatively simple, as shown in FIG. 10. During normal operation, the grid rectifier 32 simply regulates the voltage on its output at a level corresponding to the ‘float voltage’ 45 of the batteries. The load inverter 33 in turn regulates AC frequency and voltage at its output, and power flow is determined by the load impedance 46. This power flow is transferred to the grid rectifier 32 by it simply maintaining the battery float voltage. When a grid power quality event occurs, the grid rectifier 32 goes offline and power is inherently picked up the batteries 10 as the DC input voltage to the load inverter 33 drops.

Control of an Inline hybrid BES System as shown in FIG. 7 is considerably more complicated, and will be explained with reference to FIG. 7. The modulation of frequency regulation power on top of the power demanded by the load inverter 33 means, by definition, the grid rectifier 32 can't operate in a DC voltage regulation mode. Instead it needs to feed the necessary load power 65 to the load Inverter 33, inject power to the grid to frequency regulate 72 on command by the electrical system operator, and maintain the state of charge of the power battery group 76. Therefore, all three of these references/signals need to be summed 70 to generate a power reference 71 for the Grid Rectifier. In addition, a SoC power reference 75 has to be derived 74 from a SoC regulator 73, which maintains the SoC of the power battery group 10 within an acceptable range. Note that this control scheme is independent of whether the Inline BES System uses a single battery group or two battery groups (i.e. the hybrid configuration).

In respect to the load inverter 33, its control remains the same in principle as the traditional system, which is regulation of AC voltage and frequency.

The reserve battery group 11 needs to operate differently when the BES system is in frequency regulation mode (REG Mode) from when it is in UPS mode. In the REG mode the Reserve Battery Group isn't used, and for this reason, in this application, these batteries are ‘float’ batteries and need to be held at a constant ‘float’ voltage. Switch 60 controls the operation mode, between REG and UPS.

In the UPS mode both the power battery group 10 and reserve battery group 11 need to discharge power in place of the grid rectifier. To accomplish this, the DC converter power reference is a ratio 63 of the Load Inverter power 65, which is derived by a multiplier 61 and a ratio reference, and the output of the multiplier 61 is output to control the DC converter 15. The power battery group automatically makes up for the power difference.

It will be appreciated that the implementations described are not exhaustive, and that many other implementations of the present invention are possible. Variations and additions are possible within the general inventive concept disclosed.

What is claimed is:

1. A power conversion and control system, comprising:
a power battery group and an energy battery group;
a DC converter connected to the energy battery group; and
a bus receiving out from the DC converter, and being directly connected the power battery group, so that operatively the bus voltage is variable.

2. A system according to claim 1, wherein the bus is connected to an inverter for output to a load.

3. A system according to claim 2, further comprising a transformer connected to an output of the inverter.

4. A system according to any one of the preceding claims, wherein a difference in response time is provided between the inverter and the DC converter.

5. A system according to claim 1, wherein the bus is connected to a grid via a grid rectifier, and to a load via a load inverter.

6. A system according to claim 1, wherein batteries for the power battery group differ from the batteries for the energy battery group in one or more of battery technology, capacity, operational characteristics or response times.

7. A system according to any claim 2, wherein the DC converter is controlled by a control signal, the control signal being derived from a power reference for the system.

8. A power conversion and control system, comprising:
a battery group, connected to an input of a load inverter, and to an input of a grid rectifier;
wherein the system is adapted to provide frequency regulation power to a grid, to supply load power to a load via the load rectifier, and to provide charging power to maintain the state of charge of the battery; and
wherein signals indicative of the load power, frequency regulation power and charging power are summed by an adder in order to provide a control signal for the grid rectifier.
